(19) United States
(12) Patent Application Publication
(10) Pub. No.: US 2018/0350492 A1
(43) Pub. Date: Dec. 6, 2018

(54) Iron Core Joint Structure of Stationary Induction Apparatus and Iron Core Joint Method

(71) Applicant: Hitachi, Ltd., Chiyoda-ku, Tokyo (JP)

(72) Inventors: Akira NISHIMIZU, Tokyo (JP); Naoyuki KURITA, Tokyo (JP); Chie KOBAYASHI, Tokyo (JP); Hisashi MOROOKA, Tokyo (JP)

(21) Appl. No.: 15/777,068

(22) PCT Filed: Nov. 18, 2015
(86) PCT No.: PCT/JP2015/082335

§ 371 Date: May 17, 2018

(51) Int. Cl. H01F 3/04; H01F 41/02

(52) U.S. Cl. CPC H01F 3/04; H01F 41/0213

(57) ABSTRACT

Generation of broken pieces of thin magnetic ribbons is reduced with respect to a joint part of an iron core, which is formed by laminating the thin magnetic ribbons, of a stationary induction apparatus. There is provided an iron core joint structure of the stationary induction apparatus characterized such that in a butt joint part of the iron core, which is configured with the laminated thin magnetic ribbons, of the stationary induction apparatus, a first resin penetrated into the laminated magnetic ribbons is applied to each of butt joint surfaces facing each other, and a second resin is further applied to an outer side of the first resin.

### TECHNICAL FIELD

The present invention relates to an iron core joint part structure of a stationary induction apparatus and an iron core joint method.

### BACKGROUND ART

A stationary induction apparatus is a transformer that changes a voltage by a reactor which adjusts an impedance or by magnetic coupling through using an action of a magnetic field. This is a product roughly configured with an iron core and a winding.

The iron core is a region relevant to basic specifications such as the number of turns of the winding by a magnetic flux density and a cross-sectional area thereof. Electromagnetic steel sheets or thin magnetic ribbons are used as structure materials of the iron core. While a quality of the materials depends on a use, a power transformer such as a transformer or a pole transformer for use in, for example, an electric power substation uses an iron core having a structure in which the electromagnetic steel sheets or iron-based amorphous materials are laminated.

The transformer has a structure in which the iron core crosses the winding; thus, the iron core is manufactured through manufacturing procedures of inserting the winding into the iron core in a state in which part of the iron core is open and then covering an open portion with the same material. For this reason, a joint part is present in the iron core, The joint part is important from the viewpoint of a loss of the iron core.

There is known a transformer using the thin magnetic ribbons and configured, for example, such that the thin ribbons are laminated and hardened by an adhesive to form an iron core. However, such an iron core is hardly used in the transformer or the pole transformer for use in the electric power substation described above due to an increase in the loss resulting from a stress applied to magnetic materials from the adhesive. In many cases, instead, a wound iron core that is an iron core formed by partially laminating two end portions of each of magnetic materials laminated without using the adhesive is used.

As regards the joint part of the iron core, a structure as shown in Patent Document 1 is disclosed. Patent Document 1 proposes a transformer assembly method including dipping first and second core pieces and a bobbin around which a coil is wound in a varnish solution to impregnate the first and second core pieces and the bobbin with varnish; applying an adhesive to the bobbin and inserting the bobbin into the first and second core pieces (iron core pieces); connecting the first and second core pieces (iron core pieces) with an insulating material pinched therebetween while abutting the bobbin on the first and second core pieces (iron core pieces); and applying the adhesive to a joint part between the first and second core pieces (iron core pieces).

### PRIOR ART DOCUMENT

### Patent Document

Patent Document 1: JP-2005-057016-A

### SUMMARY OF THE INVENTION

### Problem to be Solved by the Invention

However, when the iron core in which the thin magnetic ribbons are laminated is used in the power transformer such as the transformer or the pole transformer for use in the electric power substation described above, it is considered that the iron core weighs several 100 kilograms to several tons. If a treatment of Patent Document 1 is carried out, then the varnish penetrates into lamination intermediates between the laminated thin magnetic ribbons of the iron core dipped in the varnish solution, and it takes time to dry the iron core.

The adhesive that bonds the iron cores together is continuously liable to an electromagnetic force of the iron core during operation, so that there is a concern of deterioration of the adhesive. If the thin magnetic ribbons are exposed as a result of the deterioration, broken pieces of the thin magnetic ribbons float within the transformer to cause dielectric breakdown. In these circumstances, therefore, the present invention provides a structure for reducing generation of broken pieces and a manufacturing method with respect to a structure of joint surfaces of an iron core configured with laminated thin magnetic ribbons.

### Means for Solving the Problems

To solve the problem, an iron core joint structure of a stationary induction apparatus according to the present invention is characterized in that in a butt joint part of the iron core, which is configured with the laminated thin magnetic ribbons, of the stationary induction apparatus, a first resin penetrated into the laminated magnetic bodies is applied to each of butt joint surfaces facing each other, and a second resin is further applied to an outer side of the first resin.

### Effect of the Invention

According to the present invention, it is possible to reduce generation of broken pieces of thin magnetic: ribbons with respect to a joint part of an iron core, which is formed by laminating the thin magnetic ribbons, of a stationary induction apparatus.

### BRIEF DESCRIPTION OF THE DRAWINGS

FIG. 1 shows an embodiment of the present invention.

FIG. 2 is an explanatory diagram of an iron core of a stationary induction apparatus.

FIG. 3 shows an iron core formed by being cut at two portions.

FIG. 4 shows an embodiment of the present invention.

FIG. 5 shows an iron core formed with a plurality of wound iron cores.

### MODES FOR CARRYING OUT THE INVENTION

Embodiments of the present invention will be described hereinafter.

A structure called “wound iron core” is normally used as a structure of an iron core, which uses thin magnetic ribbons, of a transformer. The wound iron core has the structure in which the thin ribbons are laminated in a radial direction and connected so that the thin ribbons are partially overlaid.

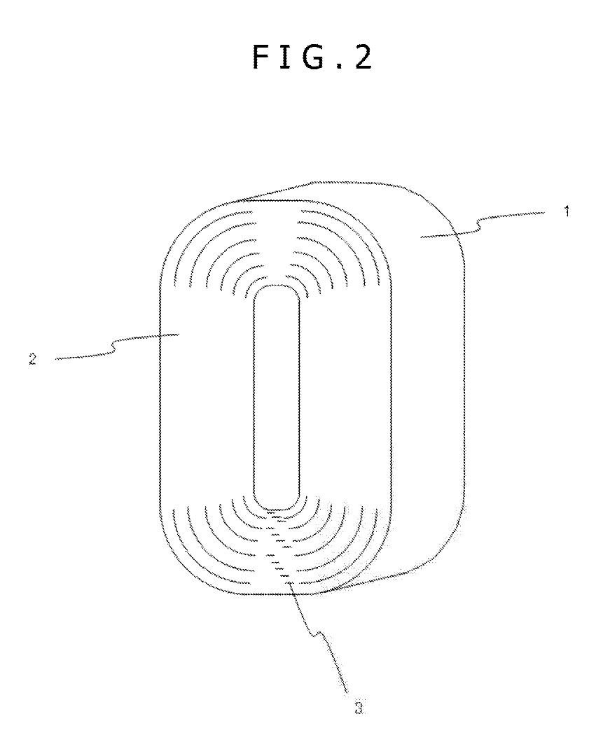

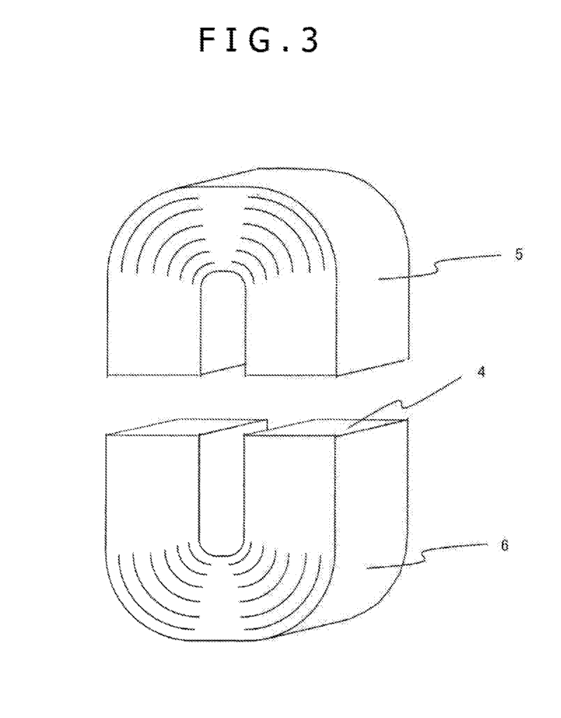

FIG. 2 is an explanatory diagram of the wound iron core. Reference character 1 denotes a wound iron core body, 2 denotes a lamination surface, and 3 denotes a joint part in which thin ribbons are overlaid. For manufacturing a large-sized iron core, in particular, it is conceivable that the iron core is configured by, for example, dividing the iron core into a plurality of regions. FIG. 3 shows a case of forming the iron core by cutting the iron core at two portions. In this case, a transformer is formed by cutting the iron core at the two portions,, dividing the iron core into an upper iron core 5 and a lower iron core 6, and assembling the upper iron core 5 and the lower iron core 6 again after insertion of a winding.

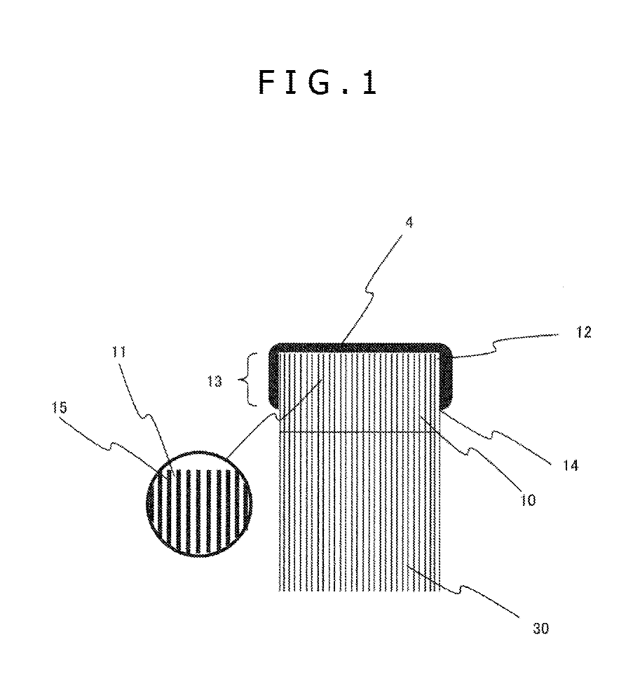

It is supposed, for example, that Fe-based amorphous materials are used. In this case, a thickness of each Fe-based amorphous material is about 25 μm, so that several thousands of Fe-based amorphous materials are laminated to have a thickness of about 100 mm. Lamination surfaces 4 are continuously liable to an electromagnetic attractive force while the transformer is in operation. Owing to this, the upper iron core 5 and the lower iron core 6 repeatedly strike against each other by the magnetic attractive force on the lamination surfaces 4. As a result, the thin magnetic ribbons are broken, and broken pieces thereof float within the transformer, which causes deterioration of an insulation performance. To address the problem, a structure shown in FIG. 1 is used to inhibit generation of the broken pieces.

### First Embodiment

A first embodiment of the present invention will be described with reference to FIG. I. The present structure is intended to suppress the broken pieces of the thin magnetic ribbons from flying by providing an application material on each lamination surface 4 that faces that of a counterpart iron core in the joint part. Specifically, an A-material that has a low viscosity and that is finally hardened is applied to the lamination surface 4, as described in detail below. It is thereby possible to penetrate the A-material into lamination intermediates 11 between laminated thin magnetic ribbons 15 as shown in an enlarged view in FIG. 1, and to apply the A-material to not only each lamination surface 4 but also a region at a certain width as indicated as an A-material penetration region 10 in FIG. 1. It is thus possible to suppress the broken pieces of the thin magnetic ribbons from flying outside even if the thin magnetic ribbons are broken by an external force.

Furthermore, after applying the A-material, a B-material 12 hardened in a state of a low modulus of elasticity is applied. The B-material 12 is applied in such a manner as to cover each lamination surface 4 which faces that of the counterpart iron core in the joint part and a side surface 13 of the iron core with the B-material 12. The A-material is penetrated into lamination intermediates 11 between the magnetic materials 15 and hardened; thus, applying the B-material to the lamination surface 4 can facilitate application work without penetration of the B-material 12 into the lamination intermediates again. This enables a region beyond the lamination surface 4 to be covered with the B-material 12; thus, it is possible to further inhibit the broken pieces from flying into the transformer.

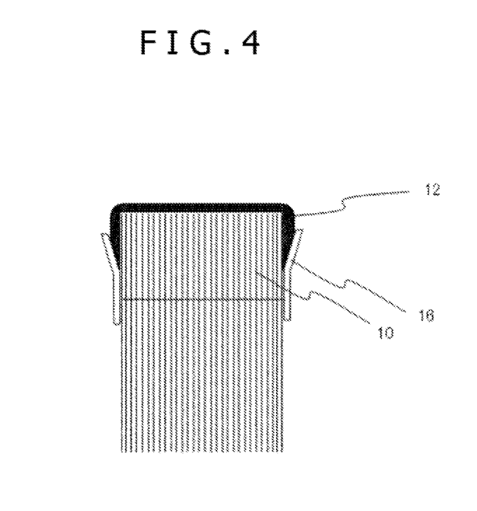

FIG. 4 shows a structure for preventing the B-material 12 from peeling off from an end surface 14. It is considered that a contact state of the end surface 14 of the B-material 12 is partially poor due to, for example, a foreign substance or the like, and that the applied B-material 12 peels off from the portion. To address the peeling, the structure is provided such that a cover 16 is wrapped around the end surface 14 of the B-material so that the end surface 14 thereof is covered with the cover 16 on a side surface of the iron core. The cover 16 can be realized by using an insulating material of a tape shape. It is thereby possible to take measures against the peeling of the B-material from the end surface 14 thereof.

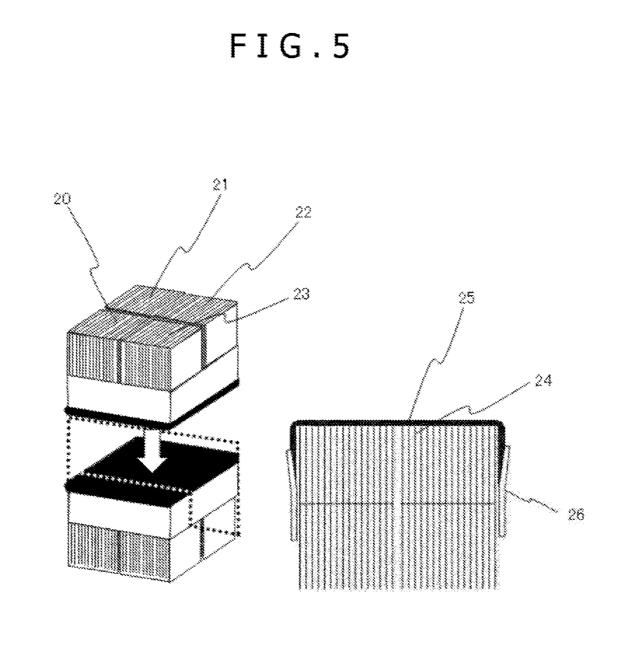

FIG. 5 shows an embodiment for forming an iron core with a plurality of wound iron cores. This is needed when a large-sized iron core is manufactured. In a case of configuring the iron core using the plurality of iron cores, the iron core is configured as follows although each iron core is identical in structure to those according to the first and second embodiments.

In FIG. 5, the iron core has four wound iron cores 20, 21, 22, and 23. In this case, the four iron cores are configured to provide interlinkage with the winding. That is, as shown in FIG. 5, the iron core is formed by a combination of the four iron cores. In a case of such a configuration, the A-material that has the low viscosity and that is finally hardened is applied to each lamination surface 4, which faces that of the counterpart iron core in the joint part, of each of the iron cores 20, 21, 22, and 23. A cover 26 is then wrapped to integrate the four iron cores.

After integration, a B-material hardened in the state of the low modulus of elasticity is applied to cover the A-material. The B-material 25 is applied in such a manner as to cover each lamination surface 4 which faces that of the counterpart iron core in the joint part and the side surface of each of the iron cores with the B-material 25. To prevent the B-material 25 from peeling off from the end surface thereof, the structure is provided such that the cover 26 is wrapped around the end surface thereof so that the end surface thereof is covered with the cover 26 on the side surface of each of the iron cores. Such a configuration can inhibit the broken pieces of the thin magnetic ribbons from flying into the transformer even if the iron core is formed with the plurality of wound iron cores.

For example, a material that has a viscosity equal to or lower than 10 Pa·s during application and a modulus of elasticity equal to or lower than 10 MPa during hardening with hardening time being equal to or longer than 30 minutes is used as the A-material, and a material that has a modulus of elasticity equal to or lower than 1.0 GPa is used as the B-material. Specifically, a silicone resin, an acrylic-modified silicone resin, an epoxy-modified silicone resin, or a mixture resin of a phenol resin and a rubber at a low viscosity is used.

In the present embodiments configured as described so far, a butt joint part structure characterized as follows is provided. The butt joint part structure is configured with a first resin penetrated into laminations on each butt surface in a butt joint part of an iron core, and a second resin covering the butt surface. A material that has a low viscosity and that is finally hardened is used as the first resin. A material that has a high viscosity during application and that is finally hardened in a state of a low modulus of elasticity is applied as the second resin after application of the first resin. Realizing the butt joint part structure characterized as described above makes it possible to provide a joint part structure that inhibits the broken pieces of the thin magnetic ribbons from flying within the transformer.

### DESCRIPTION OF REFERENCE CHARACTERS

1: Wound iron core
2: Lamination surface
3: Thin magnetic ribbon
4: Lamination surface
5: Upper iron core
6: Lower iron core
10: A-material penetration region
11: Lamination intermediate
12: B-material
16: Cover
20: Element of a plurality of iron cores
21: Element of a plurality of iron cores
22: Element of a plurality of iron cores
23: Element of a plurality of iron cores

1. An iron core joint structure of a stationary induction apparatus, wherein
in a butt joint part of an iron core, which is configured with laminated thin magnetic ribbons, of the stationary induction apparatus,
a first resin penetrated into the laminated magnetic: bodies is applied to each of butt joint surfaces facing each other, and
a second resin is further applied to an outer side of the first resin.

2. The iron core joint structure of the stationary induction apparatus according to claim 1, comprising
a member that covers an end portion of the second resin.

3. The iron core joint structure of the stationary induction apparatus according to claim 2, wherein
the member that covers the end portion of the second resin exhibits an electric insulation performance.

4. The iron core joint structure of the stationary induction apparatus according to claim 1, wherein
the first resin has a viscosity equal to or lower than 10 Pa·s during application and a modulus of elasticity equal to or lower than 10 MPa during hardening, and
the second resin has a modulus of elasticity equal to or lower than 1.0 GPa.

5. An iron core joint method for a stationary induction apparatus, comprising:
in a butt joint part of an iron core, which is configured with laminated thin magnetic ribbons, of the stationary induction apparatus,
applying a first resin penetrated into the laminated magnetic bodies to each of butt joint surfaces facing each other; and
further applying a second resin to an outer side of the first resin.
